(19) United States
(12) Patent Application Publication
(10) Pub. No.: US 2016/0328519 A1
(43) Pub. Date: Nov. 10, 2016

(54) Systems and Methods for Virtual Triage

(71) Applicants: Stephen Cox, Alpharetta, GA (US); Nirag Nagada, Atlanta, GA (US)

(72) Inventors: Stephen Cox, Alpharetta, GA (US); Nirag Nagada, Atlanta, GA (US)

(21) Appl. No.: 14/706,167

(22) Filed: May 7, 2015

(51) Int. Cl. G06F 19/00

(52) U.S. Cl. CPC G06F 19/322; G06F 19/327

(57) ABSTRACT

A system and method is provided for performing patient triage via a remote processor based device. A patient logs onto the system, enters information which is transmitted to a medical professional who makes determinations related to treatment and whether or not to meet with the client in person based at least in part on the information entered.

### FIELD OF THE INVENTION

This disclosure relates generally to patient intake procedures and more particularly but not exclusively to systems and methods for obtaining and confirming patient information prior to an in person meeting with a doctor.

### BACKGROUND OF THE INVENTION

Nobody enjoys long waits in a doctor's office or at a hospital before being seen by a doctor. However, the nature of a conventional doctor visit encourages exactly this. Due to various factors (e.g. patient questions, non-medical conversations, time to evaluate a patient, need to schedule different procedures, time to obtain medications, etc.) it is difficult for a doctor to estimate the amount of time it will take for each patient and thus he or she must ask patients to arrive based on an average expected amount of time each visit should take.

In addition to the wait time issue, insurance companies are forcing doctors to accept less money for each visit and thus a doctor needs to find a way to be able to see more patients.

It would thus be advantageous to create an automated or semi-automated system or process that could be employed to triage a patient before the physical in person meeting with a doctor. It would be further advantageous to create such a device or process that could answer simple patient questions. It would also be advantageous to create such a device or process that could obtain preliminary information from a patient such as insurance, current patient medications, allergies etc.

### BRIEF SUMMARY OF THE INVENTION

Many advantages of the invention will be determined and are attained by the invention, which in a broad sense provides automated systems and methods for patient triage. In at least one embodiment a method for patient triage is provided. The method includes obtaining patient information via a processor based device, confirming at least a portion of the patient information, reviewing the patient information and based on the review determining whether to have the patient meet with a medical professional or have the patient provide additional information via the processor based device. The method also includes obtaining consent from the patient via the processor based device and prescribing treatment to the patient via the processor based device.

In one or more implementations of the invention, a system for remote triage of a patient is provided. The system includes a patient processor based device which includes a display and an input device. The system also includes an application running on the patient processor based device configured to receive information from the patient and transmit the information for receipt by a server via a network. The server is in electrical communication with the network and includes a database for storing at least a portion of the information. The system also includes a medical professional processor based device which includes a display and an input device. The system also includes an application running on the medical professional processor based device configured to access the information from the database and configured to enable the medical professional to contact the patient via the app on the medical professional processor based device and the app on the patient based processor based device.

The invention will next be described in connection with certain illustrated embodiments and practices. However, it will be clear to those skilled in the art that various modifications, additions and subtractions can be made without departing from the spirit or scope of the claims.

### BRIEF DESCRIPTION OF THE DRAWINGS

For a better understanding of the invention, reference is made to the following description, taken in conjunction with the accompanying drawings, in which like reference characters refer to like parts throughout, and in which:

FIG. 1 is a flow diagram illustrating a system in accordance with one or more embodiments of the invention; and,

FIG. 2 is a block diagram of a system in accordance with one or more embodiments of the invention.

The invention will next be described in connection with certain illustrated embodiments and practices. However, it will be clear to those skilled in the art that various modifications, additions, and subtractions can be made without departing from the spirit or scope of the claims.

### DETAILED DESCRIPTION OF THE INVENTION

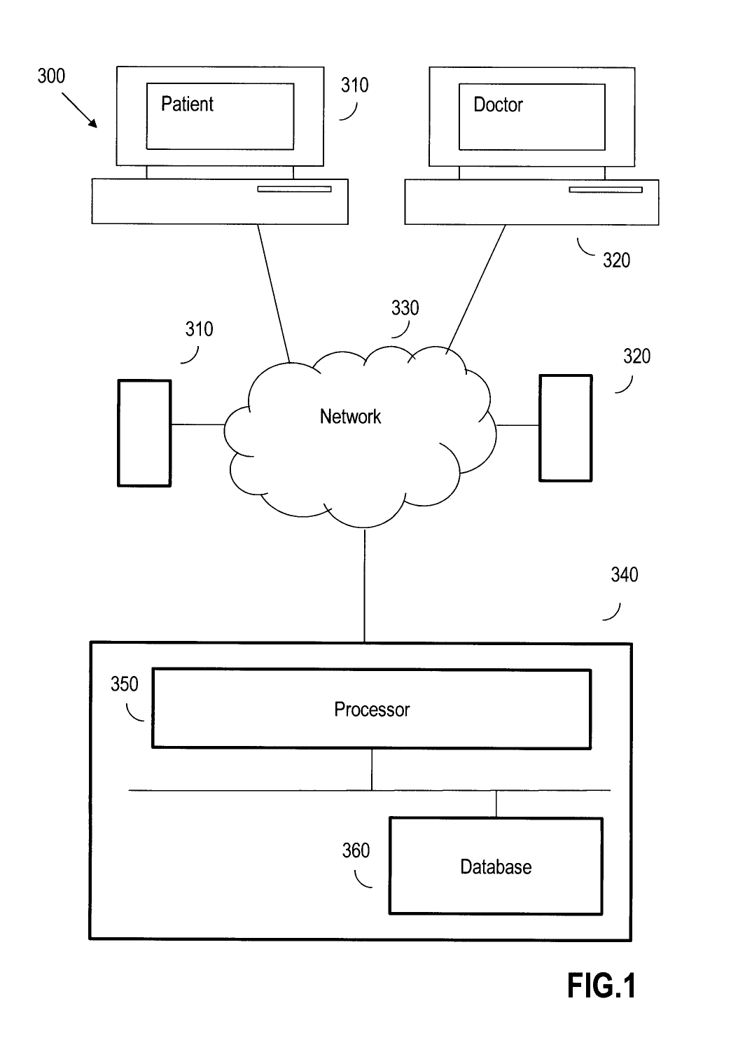

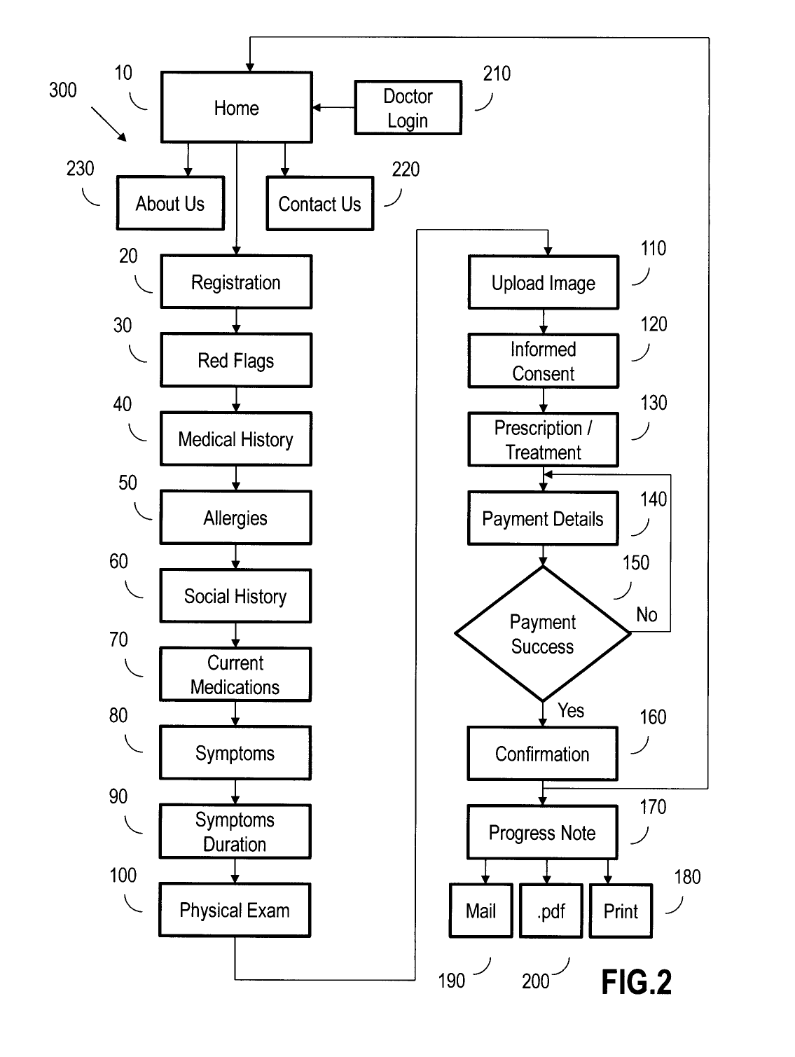

Referring to the drawings in detail wherein like reference numerals identify like elements throughout the various figures, there is illustrated in FIGS. 1-2 a system and method for patient triage. While FIG. 2 illustrates one computer 310/320 and a mobile device 315/325 for both the doctor and the patient, those skilled in the art will recognize that the invention is not so limited. There could be more than or fewer than one computer 310/320 and one mobile device 315/325 for both the doctor and patient and still fall within a scope of one or more embodiments of the invention. Additionally, while FIG. 2 illustrates a single network 330 and a single server 340 connected to the network 330 there could be more than one network 330 and more than one server 340. Additionally, there may be more than one type of network 330 (e.g. the Internet, a private network, and virtual private network (VPN), a telephone network, etc.) and it/they may be secure or unsecure and still fall within a scope of one or more embodiments of the invention. It is contemplated that the systems and methods may be employed with various mobile devices 315/325 such as personal digital assistants (PDA), mobile phones, tablets, e-readers, portable game units, smart watches, etc. and/or with various computers 310/320 such as laptops, desktops, thin clients etc. The principles and operations of the invention may be better understood with reference to the drawings and the accompanying description. For purposes of the following description, the word triage may be used to refer to anything from obtaining the patient information to a full blown diagnosis and treatment.

In a preferred embodiment as illustrated in FIG. 2, the system 300 includes a patient processing device 310/315 which the patient uses to access the triage program. The triage program may be an application on a mobile device and/or it may be a website that the user accessing via the Internet 330 or some other network 330 and/or it may be a program that resides on their device 310/315. For ease of description, the remainder of the disclosure will focus on a patient using a mobile device 315, but those skilled in the art will recognize that the description is easily applied to a stand-alone computer. The system also includes a remote server 340 which includes one or more processors 350 and one or more databases 360. The server 340 may store (temporarily or permanently) information such as user profiles, information about various medicines, insurance information, information about one or more doctors and/or practices and or any other conventional information that is stored on such servers. The storage of information and the type of information stored presently exists and thus the process or storage and the information stored will not be further examined. Most mobile devices include a camera (not illustrated) which may be used for one or more features of the invention. The system may also include a processing device 320/325 that a doctor may use to access the system. As with the patient device, the remainder of the disclosure will focus on a doctor using a mobile device 325, but those skilled in the art will recognize that the description is easily applied to a stand-alone computer 320.

Operation of one or more embodiments is illustrated in FIG. 1. While FIG. 1 lists the various steps in a particular order this is a design choice and other orders of operation are possible without departing from a scope of one or more embodiments of the invention. For each step or any part of one or more of the steps the system 300 may provide choices (e.g. radio check boxes or scroll down choices or any other conventional options) to the patient and/or help (e.g. a more detailed explanation of the requested information). A patient accesses the system 300 using an app located on a mobile device 315. While the following description is limited to the patient accessing the system via a mobile app, those skilled in the art will recognize that the description is easily applicable to logging on directly via a webpage. The app provides the patient with various options (e.g. find out about the doctor/practice 230, contact the doctor/practice 220, login/register 20 etc.) While only 3 options are illustrated, those skilled in the art will realize that the invention is not so limited. Other options such as search for a doctor, search for a practice, nearest hospital(s), emergency access (e.g. selection of this option may bypass all steps and place patient directly in contact with a person who can analyze the emergency—either by phone call, video call or text), etc. may also be provided. Additionally, it is possible that fewer options are available prior to logging in with a username and password 20.

The first time the patient accesses the system they will be asked to register 20. Registration 20 may include one or more of the following: selecting a username and password, entering full name, contact information (e.g. phone number(s), email(s), address(es)), citizenship, insurance information (carrier(primary/secondary), account number, employer, employer contact information, primary insured, etc.). This information may be stored locally to the patient's device 315 and/or remotely at server 340 depending on the design choice. The system 300 may check the registration information (e.g. is the insurance information correct, is the employer name correct, does the address match, is all requested information entered, etc.) This may be done automatically by the system or manually by a person assigned to this task. The system 300 also provides the patient with the option to enter or select from a list of red flags 30 (e.g. severely high fever, chest pain, or any other symptom deemed by the medical provider to need more thorough evaluation). If any red flag symptoms are entered or chosen by the patient, the patient is directed to get further assessment via a traditional medical examination at an emergency room (ER) or clinic. Once the patient is registered, if not directed to the ER or some other medical facility, the system requests past medical history 40 (e.g. injuries, surgeries, diseases, etc.) The user will have the opportunity to list unlisted past medical history. Next the system 300 requests known allergies 50 and social history 60 (e.g. smoker, drinker, sexual habits, sexually transmitted disease, etc.).

Each time the patient accesses the app, whether or not it is the first time, the system requests a list of current medications 70 the patient is using (both prescription and over the counter). Optionally the system 300 will review the list of medications 70 for adverse combinations or contra indicated medications for the particular patient (e.g.

someone with a history of diabetes should not take certain medications, someone who is allergic to penicillin should not take certain medications etc.) and set an alert for the patient and/or doctor if such a situation is detected.

After acquiring the current medications 70 the system provides the patient with the opportunity to enter one or more symptoms 80 that they are experiencing. As with the previous steps, this could provide a list of options for the patient and/or an option to manually enter the symptom(s). For certain symptoms deemed to need more evaluation by the provider, the patient will be directed to get further assessment via a traditional medical examination at an ER or clinic. The system 300 also requests the patient to enter the length of time 90 the patient has been experiencing each symptom. At this point 90 and/or at the previous point 80 the system may optionally compare the symptoms and durations to known emergency/hazardous situations and alert the patient and/or the doctor or doctor's office that immediate attention is required if the symptom and or the combination of symptom and duration matches a known situation.

Once all of the above information is entered, it is time for the physical examination 100. This examination 100 can either be done by a physical, in person meeting with the doctor or another medical professional or it can be done via a telephone conversation, video connection, remote electronic otoscope, remote electronic stethoscope, remote electronic vital sign device and/or text conversation. The patient may be asked to read a script summarizing his or her symptoms. The doctor or medical professional may request the patient to take one or more photographs 110 and/or video 110 of the patient and upload the video to the server or to send the video via text or email. The provider may use the photo and video information as part of the physical exam, judging alertness, apparent wellness or distress, labored or non-labored breathing, and respiratory rate. The doctor or other medical professional may review the photograph(s)/video(s) and make a determination whether or not the patient needs to be brought in for a physical meeting or whether or not the patient can be diagnosed and treated based on the available information. In the event that the patient can be treated remotely, the system provides the patient with an informed consent form 120 to review and sign. Once the consent is granted the doctor or other medical professional prescribes the appropriate medications and/or treatment 130.

Once treatment/medication is prescribed, the patient is requested to enter payment information 140 (e.g. credit card, debit card, PayPal, etc.) to cover the deductible or if no insurance, the entire cost for the exam. If the payment information is correct and authorized by the bank a confirmation and receipt 160 is provided to the patient. In other uses of the app, payment may be collected at a traditional clinic where the app is employed. If warranted, the patient may be asked to return to the app for a follow-up visit as indicated by the line returning to the start 10. At the end of a visit, the patient may be provided with a progress note 170 which may be printed 200, saved in a .pdf format 190 or some other available format 190 and or mailed 180 or emailed 180 to the patient.

Optionally, at any time while the patient is progressing through the app, the doctor or some other medical professional may login 210 and attempt to contact the patient. Those skilled in the art will recognize that the doctor or other medical professional may already be logged in prior to the patient accessing the app. If the doctor or other medical professional attempts to contact the patient via the app, a pop-up or some other indicator may appear on the patient's mobile device 315 and the patient will have the opportunity to accept the contact, reject the contact or delay the contact. These choices are a design choice and the patient may not be provided with any of these options or may be provided with less than all of these options. In one or more embodiments, once the patient reaches the physical exam portion 100 the doctor or other medical personnel is notified and at that point has the option to connect with the patient, have the patient come in to the doctor's office or allow the patient to continue with the app. The doctor or medical provider may elect to record a video clip of him or herself explaining the treatment plan that can be reviewed by the patient at a later time.

It is currently anticipated that the invention will be provided to patients when they enter the doctor's or hospital's waiting room and that the app will be provided on a mobile device provided by the doctor's office to ensure HIPAA compliance. However, it is also contemplated that the invention may be used on a patient's own mobile device if HIPAA security requirements are taken into consideration and met.

In one or more embodiments the invention is employed by a triage nurse or some other medical personnel (referred to in the remainder of this paragraph as the triage nurse) rather than by a patient. The patient arrives at the doctor's office or hospital and is evaluated by a triage nurse. The triage nurse registers the patient 20, the information is checked for red flags 30. The triage nurse obtains and enters past medical history 40, allergies 50, social history 60, medications 70, and symptoms 80. The triage nurse then takes the patient's vital signs (blood pressure, heart rate, respiratory rate, pulse, oxygen levels, etc.) 100 and takes images 110 and/or video 110 of the patient and uploads it to the patient's file. The remainder of the transaction is the same as discussed above. Alternatively, the patient could perform any of steps 10 through 120 and the triage nurse could enter the picture at any time therein.

Having thus described preferred embodiments of the invention, advantages can be appreciated. Variations from the described embodiments exist without departing from the scope of the invention. Thus it is seen that triage systems and methods are provided. Although particular embodiments have been disclosed herein in detail, this has been done for purposes of illustration only, and is not intended to be limiting with respect to the scope of the claims, which follow. In particular, it is contemplated by the inventors that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implemented, at least in part, using a computer system, it will be appreciated that a computer program for implementing at least part of the described methods and/or the described systems is envisaged as an aspect of the invention. The computer system may be any suitable apparatus, system or device, electronic, optical, or a combination thereof. For example, the computer system may be a programmable data processing apparatus, a computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

It is accordingly intended that all matter contained in the above description or shown in the accompanying drawings be interpreted as illustrative rather than in a limiting sense. It is also to be understood that the following claims are intended to cover all of the generic and specific features of the invention as described herein, and all statements of the scope of the invention which, as a matter of language, might be said to fall there between.

Having described the invention, what is claimed as new and secured by Letters Patent is:

1. A method for patient triage, the method comprising:
obtaining patient information via a processor based device;
confirming at least a portion of said patient information;
reviewing said patient information and based on said review determining whether to have the patient meet with a medical professional or have the patient provide additional information via the processor based device;
obtaining consent from said patient via said processor based device; and,
prescribing treatment to said patient via said processor based device.

2. The method according to claim 1 further comprising:
obtaining an image of said patient via said processor based device, wherein said prescribing treatment is based at least in part on said obtained image.

3. The method according to claim 2 wherein the image is a photograph.

4. The method according to claim 2 wherein the image is a video image.

5. The method according to claim 2 wherein the image is obtained by a medical professional.

6. The method according to claim 1 further comprising contacting said patient via said processor based device while said patent information is being obtained.

7. The method according to claim 1 further comprising the patient receiving a recorded video via said processor based device explaining said treatment.

8. The method according to claim 1 wherein said patient information includes one or more of the following information selected from the group of information consisting of name, address, insurance carrier, insurance account, employer, phone number, email, mailing address, citizenship, employer contact, name of primary insured, past medical history, social history, current medications, symptom, symptom duration and allergies.

9. The method according to claim 1 wherein at least a portion of said patient information is obtained by a medical professional and entered into said processor based device.

10. The method according to claim 1 further comprising comparing said patient information with a database of information and providing an alert to the patient based on said comparison.

11. The method according to claim 1 further comprising comparing said patient information with a database of information and providing an alert for receipt by a medical professional based on said comparison.

12. The method according to claim 1 further comprising receiving payment information from said patient via said processor based device; confirming said payment information and providing confirmation of payment via said processor based device.

13. The method according to claim 1 further comprising subsequent to prescribing treatment to said patient via said processor based device receiving additional information from said patient and based at least in part on said additional information providing a progress note to said patient via said processor based device.

14. The method according to claim 1 further comprising a medical professional obtaining patient vital signs from said patient and entering said vital signs into said processor based device.

15. A system for remote triage of a patient, the system comprising;
a patient processor based device which includes a display and an input device;
an application (app) running on said patient processor based device configured to receive information from said patient and transmit said information for receipt by a server via a network;
said server in electrical communication with said network and including a database for storing at least a portion of said information;
a medical professional processor based device which includes a display and an input device; and,
an application running on said medical professional processor based device configured to access said information from said database and configured to enable said medical professional to contact said patient via said app on said medical professional processor based device and said app on said patient based processor based device.

16. The system according to claim 15 further comprising a camera connected to said patient processor based device.

17. The system according to claim 16 wherein said camera is a still image camera.

18. The system according to claim 16 wherein said camera is a video camera.
